(19) United States
(12) Patent Application Publication
(10) Pub. No.: US 2026/0293936 A1
(43) Pub. Date: Oct. 1, 2026

(54) WET FOOD COMPOSITIONS SUITABLE FOR INTESTINAL DISORDER

(71) Applicant: MARS, INCORPORATED, Mclean, VA (US)

(72) Inventors: Karine BRECIN, Aimargues (FR); Hélène CHARLES, Aimargues (FR); Sally PEREA, Lewisburg, OH (US)

(73) Assignee: MARS, INCORPORATED, Mclean, VA (US)

(21) Appl. No.: 19/480,697

(22) PCT Filed: Apr. 30, 2024
(86) PCT No.: PCT/US2024/027064

§ 371 Date: Oct. 31, 2025

(30) Foreign Application Priority Data
May 2, 2023 (EP) 23171116.9

(51) Int. Cl. A23K 50/48; A23K 10/30; A23K 20/147; A23K 20/158; A23K 20/163

(52) U.S. Cl. CPC A23K 50/48; A23K 10/30; A23K 20/147; A23K 20/158; A23K 20/163

(57) ABSTRACT

The present disclosure relates to a wet food composition for a companion animal having an intestinal disorder including, on a dry matter basis: (a) from about 15% to about 45% by weight of protein; (b) from about 5% to about 25% by weight of fat; (c) from about 6% to about 14% by weight of Total Dietary Fibers (TDF); wherein at least about 50% by weight of the total amount of TDF, on a dry matter basis, originates from psyllium.

### CROSS-REFERENCE TO RELATED APPLICATIONS

This application claims the benefit of priority to European Patent Application No. 23171116.9 filed on May 2, 2023, the contents of which are incorporated herein by reference in their entirety.

### FIELD OF THE DISCLOSURE

The present disclosure relates to the field of wet food compositions for companion animals and their use for managing intestinal disorders.

### BACKGROUND OF THE DISCLOSURE

Constipation is usually defined as infrequent or difficult emission of hard, dry, feces and is a common clinical complaint in companion animals. The clinical signs can result from a number of different disorders including dietary, environmental disturbances, colonic obstruction, electrolyte imbalances, iatrogenic and neuromuscular disease. Treatment involves identifying and eliminating the cause, if possible, together with medical or, in some cases, surgical management.

Dietary modification is preferentially recommended for the management of feline constipation, and recommendations generally involve the incorporation of dietary fiber, either insoluble, soluble or a mix thereof.

Among the existing soluble fiber, it can be cited psyllium. Psyllium can exhibit a low fermentability and have a husk containing both polysaccharide and non-polysaccharide components that, once ingested, release a hydrophilic mucilaginous gel thereby increasing the bulk of the feces of the subject. Thus, preparations containing psyllium can increase the frequency and consistency of feces in human suffering of idiopathic constipation.

Given the suggested benefits in humans, addition of insoluble and soluble dietary fiber, such as psyllium, has been recommended in the management of feline constipation.

In general, an existing food composition can be supplemented with a high amount of fiber, and this is most commonly done by adding psyllium as fiber content. This is particularly done with the adaptation of the formulation of existing dry food compositions for cats, especially used for managing constipation, wherein the principal fiber source, psyllium husk, is added to the dry food compositions. Further, given the use of psyllium, most of the fiber is soluble rather than insoluble in such dry food compositions.

Although there are some dry food compositions dedicated to constipation problems in cats, it remains that wet food compositions are still more recommended than dry food compositions, especially for cats.

Wet food compositions can help to ensure proper water intake for companion animals, such as for cats, and thereby can participate to the maintenance of the hydrated status of the animals, which is cornerstone as dehydration can cause or exacerbate constipation.

However, while wet food compositions provide a benefit for the management of constipation in companion animals by increasing water intake and promoting hydration, the final aspect and texture of wet food compositions are highly impacted by the content of psyllium, blocking its manufacture.

Indeed, the processability of psyllium is completely distinct in wet food compositions than dry food compositions, such as kibbles, considering the low presence of water in dry food compositions compared to the high presence of water in wet food compositions, psyllium displaying its hydrophilic properties. The difficulty lays in the high content of psyllium in the formula, and the expectations related to final composition aspect and texture of the wet food compositions. For example, in actual test formulations of wet food compositions, psyllium can migrate from the composition of the chunk to the sauce surrounding the chunk, affecting the textural properties of the sauce itself, which must remain liquid.

In addition, psyllium can affect the process as it involves a jellification of the psyllium-contained food composition at cold, or even ambient, temperatures, generating issues in emulsion and filling steps.

It has been reported that gelling properties of psyllium can change with time which can impact the conservation of the food composition. The process must be carefully controlled, and this implies the adaptation of the formulation of the wet food compositions.

At the end, these issues strongly impact the aspect of the wet food compositions. The complexity lays in the fact that consumers expect a finish composition as chunks in sauce or morsels in a liquid gravy, whereas the presence of psyllium affects the overall composition texture and its stability in time, meaning more risks to get consumer complaints with such wet food compositions such as unexpected jellification or unstable gravy. In addition, high psyllium can lead to technical issues during the production process of such food compositions (problems with filling, transport in pipes, etc.) depending on how this psyllium material is incorporated into the food compositions, and how the compositions are treated along its production.

Thus, it means that the overall formula balance must be adapted in order to have efficacious wet food compositions, with the aesthetics expected by consumers and able to be used in the context of intestinal disorders in companion animals.

Therefore, there is a need for developing further food compositions with a high level of psyllium for companion animals.

Therefore, there is a need for developing wet food compositions to be adapted for intestinal disorders, in particular constipation.

There is a need for developing wet food compositions with a high level of psyllium while still having the organoleptic properties of a wet food composition.

There is a need for developing wet food compositions with a high level of psyllium while still maintaining a suitable palatability and an aesthetic suitable with consumers' expectations.

There is a need for developing wet food compositions with a high level of psyllium which can be manufactured in repeatable conditions.

There is a need for developing wet food compositions with a high level of psyllium with acceptable stability all along shelf-life.

The present disclosure has for purpose to satisfy all or part of the above-mentioned needs.

### SUMMARY

A first aspect of the present disclosure relates to a nutritionally complete wet food composition for a companion animal having an intestinal disorder including, on a dry matter basis of from about 15% to about 45% by weight of protein, from about 5% to about 25% by weight of fat, and from about 6% to about 14% by weight of Total Dietary Fibers (TDF), wherein at least about 50% by weight of the total amount of TDF, on a dry matter basis, originates from psyllium.

In some embodiments, at least about 70% by weight of the total amount of TDF, on a dry matter basis, can originate from psyllium.

In some embodiments, the nutritionally complete wet food composition can include, on a dry matter basis, at least about 5% by weight of psyllium.

In some embodiments, the nutritionally complete wet food composition can include, on a dry matter basis, from about 5% to about 12% by weight of psyllium.

In some embodiments, from about 50% to about 70% by weight of the total amount of TDF can consist of soluble fibers, on a dry matter basis.

In some embodiments, from about 55% to about 65% by weight of the total amount of TDF can consist of soluble fibers, on a dry matter basis.

In some embodiments, from about 30% to about 50% by weight of the total amount of TDF can consist of insoluble fibers, on a dry matter basis.

In some embodiments, from about 35% to about 45% by weight of the total amount of TDF can consist of insoluble fibers, on a dry matter basis.

In some embodiments, the weight ratio of soluble fiber to insoluble fiber in a wet food composition can be from about 1:1 to about 2:1.

In some embodiments, the weight ratio of soluble fiber to insoluble fiber in a wet food composition can be from about 1.2:1 to about 1.5:1.

In some embodiments, the moisture content of the nutritionally complete wet food composition can be from about 30% to about 90% by weight of the nutritionally complete wet food composition.

In some embodiments, the nutritionally complete wet food composition can include, on a dry matter basis, from about 6% to about 12% by weight of ash.

In some embodiments, the nutritionally complete wet food composition can include, on a dry matter basis, from about 15% to about 45% by weight of starch.

In some embodiments, the nutritionally complete wet food composition can include, on a dry matter basis, from about 0.01% to about 1% by weight of Mannan oligosaccharides (MOS).

In some embodiments, the nutritionally complete wet food composition can include, on a dry matter basis, from about 0.1% to about 1% by weight of Fructo oligosaccharides (FOS).

In some embodiments, a source of soluble fiber can be selected from beet pulp, guar gum, chicory pulp, chicory root, psyllium, pectin, blueberry, cranberry, squash, apples, oats, beans, citrus, barley, peas, inulin, corn, and/or a combination thereof.

In some embodiments, a source of insoluble fiber can be selected from cellulose, whole wheat products, wheat oat, corn bran, flax seed, grapes, celery, psyllium, green beans, cauliflower, potato skins, fruit skins, vegetable skins, peanut hulls, soy fiber, beet pulp and/or a combination thereof.

In some embodiments, a highly binding protein source can be selected from a liver, a heart, a neck, plasma, carcasses, or a combination thereof.

In some embodiments, a low binding protein source can be selected from a lung, a mechanically deboned meat, viscera, entrails, a hydrolyzed meat or a combination thereof.

In some embodiments, the nutritionally complete wet food composition can be a loaf or a chunk in sauce.

In some embodiments, a companion animal can be a feline or a canine.

In some embodiments, a companion animal can be a cat or a dog.

According to a further aspect, the present disclosure relates to the use of a nutritionally complete wet food composition as described herein for managing an intestinal disorder in a companion animal.

In some embodiments, an intestinal disorder can include constipation, colitis, anal incontinence, intestinal dysmotility, megacolon, acute colitis, chronic colitis, chronic enteropathy, chronic idiopathic large bowel disease, dysautonomia, obstipation and/or inflammatory bowel disease.

In some embodiments, an intestinal disorder can consist of constipation.

According to a further aspect, the present disclosure relates to a method for managing an intestinal disorder in a companion animal comprising a step of administering a nutritionally complete wet food composition as described herein to the companion animals.

### DETAILED DESCRIPTION

A wet food composition has been developed to be used to support the management of intestinal disorders, such as, without limitation, constipation, in companion animals. The wet food composition of the disclosure includes ingredients that are advantageously formulated to maintain the organoleptic properties of the wet food composition compared to a standard wet food composition, in terms of texture, viscosity, palatability, and/or aspect. Illustratively, a standard wet food composition can be Hill's Prescription GI Biome Wet Cat Food or ROYAL CANIN® Digest Sensitive in gravy or ROYAL CANIN® Appetite Control Care loaf.

In particular, the formulation of such a wet food composition has been developed and set up specifically to allow the incorporation of a high amount of psyllium in the wet food composition while maintaining a high palatability for the companion animals consuming it while maintaining an aesthetic suitable to consumers' expectations for such wet food compositions.

The wet food composition of the disclosure is specific in the amount of psyllium added and is also specific in the adaptation of the amount of the other components. This specific combination of ingredients allows obtaining a formulation having the ability to be correctly processed to provide a final wet food composition presenting an appropriate wet texture palatability for a companion animal.

A further advantage of a wet food composition of the disclosure is its nutritional quality that is sufficient to provide all the nutrients that a companion animal needs to be healthy and maintain a stable weight.

A wet food composition generally known in the art is “chunk and gravy” that is generally meat pieces that are surrounded in a sauce. For this type of wet food compositions, there can be a diffusion of a part of psyllium from the chunk to the sauce causing a gelling of the sauce, which is either changing its textural properties with time, or changing them in an irregular way. In addition, adding psyllium into the sauce may cause issues in production (such as flowability, capacity to fill the packaging) and during shelf-life (such as setting into a hard gel then not any mor a sauce). That is one of the reasons why, it has also been proceeded to the adaptation of the formulation of the sauce.

An objective of the present disclosure is to provide a wet food composition while being palatable and with the right wet texture as expected by consumers compared to a standard wet food composition.

It is provided herein a wet food composition, which can be nutritionally complete, including a high amount of psyllium with an adapted formulation of the weight amount of ingredients composing the wet food composition.

### Definitions

The terms used in this specification generally have their ordinary meanings in the art, within the context of this disclosure and in the specific context where each term is used. Certain terms are discussed below, or elsewhere in the specification, to provide additional guidance in describing the compositions and methods of the disclosure and how to make and use them.

Exemplary methods and materials are described below, although methods and materials similar or equivalent to those described herein can also be used in the practice or testing of the present disclosure. Further, unless otherwise required by context, singular terms shall include pluralities and plural terms shall include the singular.

Units, prefixes, and symbols are denoted in their International System of Units (SI) accepted form. Numeric ranges are inclusive of the numbers defining the range. The headings provided herein are not limitations of the various aspects of the disclosure. Accordingly, the terms defined immediately below are more fully defined by reference to the specification in its entirety.

All publications and other references mentioned herein are incorporated by reference in their entirety.

As used in the specification and the appended claims, the singular forms “a,” “an” and “the” include plural referents unless the context clearly dictates otherwise. Thus, for example, reference to “a compound” can include a mixture of at least two compounds.

The term “about” or “approximately”, as used herein, means within an acceptable error range for the particular value as determined by one of ordinary skill in the art, which will depend in part on how the value is measured or determined, i.e., the limitations of the measurement system. In general, the term “about” can modify a numerical value above and below the stated value by a variance of, for example, 10 percent, up or down (higher or lower). In some embodiments, the term indicates deviation from the indicated numerical value by ±15%, ±10%, ±5%, ±4%, ±3%, ±2%, or ±1%.

As used herein, the terms “comprise”, “comprising”, “include”, “including” or any other variation thereof, are intended to cover a non-exclusive inclusion, such that a food composition, a process or a method that comprises a list of elements or ingredients which does not include only those elements or ingredients but can include other elements or ingredients not expressly listed or inherent to such food composition, process or method. The term “consisting of” implies the inclusion of the stated element(s), to the exclusion of any additional elements. The term “consisting essentially of” implies the inclusion of the stated elements, and possibly other element(s) where the other element(s) do not materially affect the basic and novel characteristic(s) of the disclosure. It is understood that the different embodiments of the disclosure using the term “comprising” or equivalent cover the embodiments where this term is replaced with “consisting of” or “consisting essentially of”.

As used herein, a “companion animal” or “pet” can be used interchangeably to refer to domestic animals. In particular, a companion animal can refer to canine and/or feline. In some embodiments, a canine can include a dog and/or a feline can include a cat.

In the detailed description herein, references to “embodiment,” “an embodiment,” “one embodiment,” “in some embodiments,” or any other variation thereof, indicate that the described embodiment(s) can include a particular feature, ingredient, structure, or characteristic, but every embodiment might not necessarily include the particular feature, ingredient, structure, or characteristic. Moreover, such phrases are not necessarily referring to the same embodiment. Further, when a particular feature, ingredient, structure, or characteristic is described in connection with an embodiment, it is submitted that it is within the knowledge of one skilled in the art to affect such feature, ingredient, structure, or characteristic in connection with other embodiments whether or not explicitly described. After reading the description, it will be apparent to one skilled in the relevant art(s) how to implement the disclosure in alternative embodiments.

As used herein, the term “food composition”, “wet food composition”, “nutritionally complect wet food composition” or “diet” covers all of foodstuff, diet, food supplement or a material that can contain proteins, fibers, carbohydrates and/or fats, which can be used in the body of an organism to sustain growth, repair and vital processes and to furnish energy. Carbohydrates includes NFE (Nitrogen free extract). A food composition can also contain supplementary substances or additives, for example, flavoring, minerals and vitamins. A food composition according to the present disclosure can consist of a nutritionally complete food composition. In some particular embodiments, a wet food composition according to the present disclosure can be a nutritionally complete wet food composition.

As used herein, “nutritionally complete” means that the composition of the present disclosure provides the complete and balanced nutritional requirement to a companion animal, such as a cat or a dog. Specifically, a nutritionally complete food composition can contain all known required nutrients for the intended recipient of the food composition, in all appropriate amounts and proportions based, for example, on recommendations of recognized and competent authorities in the field of animal nutrition. Therefore, a nutritionally adequate diet is a diet with which the said companion animal can be fed as the sole ration and is capable of sustaining life without additional food (except water). The nutritionally complete food composition can further contain a carrier, a diluent, and/or an excipient. Depending on the intended use, the carrier, diluent, and/or excipient can be chosen to be suitable for companion animal use, especially for companion animals use such as feline and canine. Further, said nutritionally complete food composition can cause no significant change in the companion animal, i.e., body weight and/or also in the Body Condition Score (BCS). Illustratively, a food composition as described herein can include, but is not limited to, protein, fat, ash, fiber (TDF), carbohydrates, starch, calcium, phosphorus, sodium, chloride, Sodium tripolyphosphate, potassium, magnesium, iron, water, copper, manganese, zinc, selenium, flavouring, vitamin A, vitamin D3, vitamin B1, vitamin B2, vitamin B6, vitamin B12, vitamin B7, vitamin B9, cholin chloride, arachidonic acid, W3 fatty acid or W6 fatty acid.

As used herein, the term “starch” refers to a polysaccharide that is composed of amylose and amylopectin. Starch occurs in many plant tissues as granules, usually between 1 and 100 μm in diameter, depending upon the plant source. Starch encompasses various crystalline structures of A-type, B-type and C-type starches, which contain different proportions of amylopectin. A-type starches are found mainly in cereals, while B-type starches are found mainly in tubers and amylose-rich starches. C-type starch consists of a mixture of both A and B forms and is found mainly in legumes. Starch incorporated in a food composition as disclosed herein can be any starch suitable for dietary purpose. Indeed, the native starch included in the starting materials used for preparing a food composition as described herein is susceptible to undergo changes during the manufacture process. If not already known by advance, the starch content of the starting materials used for preparing a food composition as described herein can be determined according to conventional techniques known in the art, and especially according to the known polarimetric method, such as according to NF EN ISO 10520. In certain embodiments, where the starting materials can include also modified starch or pre-gelatinized starch, the starch content can also be determined according to NF EN ISO 15914.

As used herein, “ash” refers to any inorganic material present in food. Ash can include minerals, such as calcium, phosphorus, sodium, chloride, potassium, magnesium, or combinations thereof. Ash can also include Sodium Tripolyphosphate (STPP) and/or an equivalent ingredient. The ash content, if specified as a result of an analytical measure of a food composition which is a measure of the total amount of minerals comprised therein. The mineral content is a measure of the amount of specific inorganic components comprised therein, which includes calcium (Ca), sodium (Na), potassium (K) and chlorine (Cl).

As used herein, the term “wet food” or “wet food composition” generally refers to a food composition that can have a moisture content of from about 30% or more to about 90% by weight relative to the total weight of the food composition. The moisture content can include the water inherently present in the ingredients of the food composition and/or supplement with added water. In general, it is the final food composition of a process including a final step of sterilization (instead of a drying step). In certain particular embodiments, the wet food composition can consist of chunks in sauce, loaf, mousse or a terrine.

As used herein, “loaf” or “ground loaf” compositions, also known as “paté”, can be typically prepared by contacting a mixture of components to produce an intracellular honeycomb-type mass or “ground loaf” which can be essentially homogeneous in most of cases but not systematically, such as in chunks in loaf. The final composition texture can vary from cream to mousse to minced or crumbly to soft “paté” or hard “paté”. The ground loaf mass can then be packaged into a container, such as a can, a tray or a pouch. Upon packing, ground loaf assumes the shape of the container such that the ground loaf has generally to be cut when serving to a companion animal.

As used herein, a “chunks” composition can include one or more natural or reformed meat piece. Reformed meat pieces are generally prepared by making a meat emulsion and by putting this meat emulsion through a muzzle under pressure and then cooked. A product, such as cooked meat, is diced into chunks, which are eventually mixed with an aqueous composition or sauce such as a gravy or a jelly. For the sake of simplification as to the reading of this specification, unless contradictory mention, the expression “sauce” shall encompass any aqueous composition or base such as gravy, jelly, broth, bouillons or any other similar aqueous base. In a similar way, the expression “chunks in sauce” shall encompass generally all “chunks in aqueous base” such as chunks in gravy, chunks in jelly, etc. The two components, i.e., the chunks and the sauce, are then filled into a container, in particular a can, a tray or a pouch, which is seamed or sealed and sterilized. As opposed to the ground loaf, chunks in sauce have physically separated, discrete chunks (i.e., pieces of ground meat and grains) present in the sauce in the final container. When serving, the chunk composition flows out of the container and can be easily mixed with other dry products.

As used herein, “organoleptic properties” refer to the sense of a food composition. Organoleptic properties can include, without limitation, smell, taste/palatability, texture and/or appearance. A food composition as described herein having suitable or advantageous organoleptic properties can include wet food compositions. A food composition as described herein having suitable or advantageous organoleptic properties can include wet food compositions having an aesthetic suitable with consumers' expectations. A food composition as described herein having suitable or advantageous organoleptic properties can include wet food compositions having a texture and/or a viscosity suitable for a wet food composition. A food composition as described herein having suitable or advantageous organoleptic properties can include wet food compositions having a desirable smell for the companion animal. The techniques to evaluate or quantify the organoleptic properties of a wet food composition are well known to a person skilled in the art. The taste or palatability or smell of a food composition can be determined with a “two-bowl test” and the viscosity of a food composition can be determined with a viscometer and/or a rheometer.

The term “ppm” or “parts per million” is herein used according to its conventional meaning. More precisely, it refers herein to a weight amount relative to the total weight of the dry matter of the food composition (e.g., mg/kg) (unless otherwise indicated).

As used herein, the term “managing” refers to ameliorate, reversing or preventing the recurrence of a particular disorder or condition of an animal having it. In some embodiments, a companion animal is administered with a wet food composition as described herein to ameliorate a condition or disorder as described herein, to reverse a condition or disorder as described herein and/or to prevent the development or worsening of a condition or a disorder as described herein. For example, the managing of constipation in a companion animal can mean improving at least one criteria usually used to define constipation for a pet: (i) straining to defecate; (ii) dry/hard stool consistency (score of 2 or less on a 5-point scale); iii) reduced frequency of defecation by one time or less per day, based on the WALTHAM® Feces scoring system.

As used herein, the terms “palatability” or “palatable” refer to being desirable to the palate or taste. Further, the terms “palatability” or “palatable” as used herein means a relative preference of an animal for one food composition compared to another food composition which are proposed to the animal at the same time. Palatability refers to the overall willingness of an animal to eat a certain food composition. Advantageously, but not necessarily, palatability further refers to the capacity of the eaten food composition to satisfy the animal. Whenever an animal shows a preference, for example, for one of two or more food compositions, the preferred food composition is more “palatable”, and has “enhanced palatability”. The relative palatability of one food composition compared to one or more other food compositions can be determined, for example, in side-by-side, free-choice comparisons, e.g., by relative consumption of the food compositions, or other appropriate measures of preference indicative of palatability. It can advantageously be determined by a standard testing protocol in which the animal has equal access to both food compositions such as a test called “two-bowl test” or “versus test”. Such preference can arise from any of the animal's senses, but typically is related to, inter alia, taste, aftertaste, smell, mouth feel and/or texture.

As used herein the term “providing” includes selling, supplying, administering, or feeding a companion animal.

As used herein, the term “weight percent” or “wt %” or “by weight” is meant to refer to the quantity by weight of a constituent/component/ingredient in a food composition as a percentage of the total weight of the food composition. The specified amount of ingredients/components comprised in a food composition as described herein consists of the amount of ingredients/components that is contained in the total amount of the raw materials which are provided for producing the said food composition.

The expression “dry matter (DM) basis” must be interpreted as a method of expressing the concentration of a nutrient or a component/ingredient in a food composition by expressing its concentration relative to its dry matter content (the concentration remaining once the moisture has been taken out). At the opposite, the expression “as fed” must be interpreted as a method of expressing the concentration of a nutrient or a component/ingredient in a food composition by expressing its concentration in the state it is fed, which includes moisture. It is appreciated that certain features of the disclosure, which are, for clarity, described in the context of separate embodiments, can also be provided in combination in a single embodiment. Conversely, various features of the disclosure, which are, for brevity, described in the context of a single embodiment, can also be provided separately or in any suitable sub-combination.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All lists of items, such as, for example, lists of ingredients, are intended to and should be interpreted as Markush groups. Thus, all lists can be read and interpreted as items “selected from the group consisting of” the list of items “and combinations and mixtures thereof.”

### Units

As used herein, an amount of a nutrient or ingredient as expressed as weight/Mcal consists of a weight amount of the said component by unit of Metabolizable Energy (ME) of the total wet food composition.

As used herein, the ME parameter is intended to represent the energy value of a food composition that is directly metabolized after consumption. Within the scope of the present disclosure, the ME value can be measured by any suitable method known in the art.

Illustratively, the ME value can be measured using feeding trial. In practice, the gross energy (GE) of the food composition is determined in the laboratory, and the amounts of food eaten by the animals are recorded. The feces and urine from the animals are collected, and the energy in each is determined and called fecal energy (FE) and urinary energy (UE), respectively. The ME is then calculated as:

$$ME ( kcal \text{/kg} ) = [ GE - ( FE + UE ) ] / Kg of food consumed .$$

Alternatively, the ME value can be measured by standard mathematical methods, taking into account, depending on the method, the percentage of crude fat (CF), of crude protein (CP), of NFE (carbohydrates) and/or of Total Dietary Fibers (TDF) in the food composition. In practice each percentage is multiplied by its respective Atwater Factors. The resulting sum is then multiplied by 10. The mathematical method can be represented by the following formula:

$$ME ( kcal \text{/kg} ) = 10 \times [ ( 3.5 \times CP ) + ( 8.5 \times CF ) + ( 3.5 \times NFE ) ] .$$

In some embodiments, the ME can be determined according to the predictive equation proposed by the National Research Council (NRC) in 2006 which is shown to be more accurate than previous ones for animal food composition.

In a particular embodiment of the disclosure, especially for feline, the ME, in kcal/100 g, can be calculated as:

$$ME = GE \times [ 95.6 - ( 0.89 \times TDF \times 100 / DM ) ] / 100 ) - ( 0.77 \times CP ) \\ or \\ ME = GE \times [ 87.9 - ( 0.88 \times CF \times 100 / DM ) ] / 100 ) - ( 0.77 \times CP ) \\ with \\ GE = ( 5.7 \times CP ) + ( 9.4 \times CF ) + [ 4.1 \times ( NFE + CF ) ]$$

In a particular embodiment of the disclosure, especially for canine, the ME, in kcal/100 g, can be calculated as:

$$ME = GE \times [ 96.6 - ( 0.95 \times TDF \times 100 / DM ) ] / 100 - ( 1.04 \times CP ) \\ or \\ ME = GE \times [ 91.2 - ( 1.43 \times CF \times 100 / DM ) ] / 100 ) - ( 1.04 \times CP ) \\ with \\ GE = ( 5.7 \times CP ) + ( 9.4 \times CF ) + [ 4.1 \times ( NFE + CF ) ]$$

### Wet Food Compositions

The present disclosure relates to wet food compositions for companion animals, in particular companion animals with intestinal disorders.

The wet food composition according to the present disclosure can be prepared according to the techniques which are well known to a person skilled in the art.

In particular, this wet food composition can include an adapted amount of fibers and others ingredients to obtain a palatable and texturized wet food composition.

In some embodiments, a wet food composition as described herein can include, on a dry matter basis, from about 15% to about 45% by weight of protein, from about 5% to about 25% by weight of fat, and from about 6% to about 14% by weight of Total Dietary Fibers (TDF), wherein at least about 50% by weight of the total amount of TDF can originate from psyllium.

It is demonstrated in the examples of the present disclosure that a wet food composition as described herein with a high amount of psyllium can surprisingly maintain its organoleptic properties while being able to manage intestinal disorders in companion animals.

In some embodiments, the wet food composition can be nutritionally complete.

In certain embodiments, the wet food composition can be packaged.

Generally, upon the wet food composition is prepared, the composition can be packaged into a container, for example a can or a pouch, which can be seamed or sealed and sterilized.

In this way, the consumer is able to identify, from the packaging, the ingredients in the wet food composition and confirm that it is suitable for the particular companion animal in question.

In certain embodiments, the packaging can be metal, plastic, paper or cardboard.

In some embodiments, the wet food composition can have a moisture content of about 30% to about 90% by weight, relative to the total weight of the wet food composition.

In some embodiments, the wet food composition can have a moisture content of about 30% to about 90%, or about 50% to about 90%, or about 70% to about 90% by weight, relative to the total weight of the wet food composition.

In some embodiments, the wet food composition can have a moisture content of about 30%, 35%, 40%, 45%, 50%, 55%, 60%, 65%, 70%, 75%, 80%, 85%, or 90% by weight, relative to the total weight of the wet food composition.

For example, and not by the way of limitation, the examples provided herein illustrate a wet food composition having a moisture content of about 82% by weight, relative to the total weight of the wet food composition.

The moisture content of a food composition can be determined by a Loss on Drying Method.

A Loss on Drying Method can include the steps of:
(a) Weighing a sample of a food composition;
(b) Heating, such as 135±2° C. for 240 minutes, the sample of step a) in an oven until the moisture is all driven off;
(c) Weighing the dry sample obtained at step (b);
(d) Calculating the difference between the total weight obtained at step (a) and the dry weight obtained at step (c), thereby obtaining the moisture weight, such as: Moisture weight=(total weight)−(dry weight).

In some embodiments, the wet food composition can include one or more natural meat pieces or one or more restructured meat pieces or a combination thereof.

Restructured meat pieces can include meat components and/or proteinaceous material from one or more sources of animal proteins that have been blended and mixed. Restructured meat pieces can further include vegetable components and/or proteinaceous material from one or more sources of vegetal proteins.

Restructured meat pieces are typically prepared by making a meat emulsion containing meat components and/or proteinaceous material from one or more sources of animal proteins, and by applying thermal energy to “set” the emulsion and allowing it to assume the desired shape, usually after cutting. Typically, in the context of the disclosure, psyllium can be added in the preparation of the meat emulsion.

In some embodiments, the wet food composition can consist of a loaf, a mousse, a terrine, a chunk or a hybrid-type food composition. In some embodiments, the wet food composition can consist of a loaf. In some embodiments, the wet food composition can consist of a chunk. In some embodiments, the wet food composition can be combined with an aqueous composition or sauce.

In particular embodiments, the chunk can be combined with an aqueous composition to provide a chunk with aqueous composition. In certain embodiments, the aqueous composition is a sauce.

In some embodiments, the wet food composition combined with sauce can be easily mixed with other ingredients. In certain embodiments the other ingredients are vegetable pieces or further meat pieces.

A sauce can include a mixture of one or more components selected from the group consisting of starches, fibers, gums, colorants, emulsifiers, salts, and palatants/flavoring compounds.

In some embodiments, a sauce can include from about 0.1% to about 10% by weight of a mixture of components other than water, relative to the total weight of the sauce.

In some embodiments, a sauce can include from about 0.2% to about 8%, about 0.5% to about 6%, about 0.5% to about 5%, or about 1% to 3% by weight of a mixture of components, relative to the total weight of the sauce.

In some embodiments, a sauce can include a mixture of components in an amount of about 0.1%, 0.5%, 1%, 1.5%, 2%, 2.5% or 3% by weight, relative to the total weight of the sauce.

In some embodiments, the mixture is starch and/or any other texturizer, and water, optionally with a flavor. The other texturizer can include hydrocolloids such as, without limitations, guar gum, xanthan gum, and carrageenan.

In certain embodiments, a sauce as described herein can include about 1% by weight of starch, about 2% by weight of flavoring and about 97% by weight of water.

In some embodiments, starch can include modified starch, pre-gelatinized starch, wheat starch, potatoes starch, rice starch, cassava starch and/or corn starch. In some embodiments, starch can include corn starch.

In some embodiments, the sauce can also include psyllium, either exclusively in sauce, or resulting from interaction with the psyllium added exclusively in wet food composition, such as chunk or loaf. For example, even if psyllium is exclusively added during the formation of the chunk or loaf, in particular chunk or loaf emulsion, when the chunk or loaf is combined with a sauce, it is not excluded that a transfer of small quantities of fiber from psyllium and more important quantities of water can occur between the chunk or loaf and the sauce. Said transfer of fiber from psyllium can occur during the storage of the food composition, before its use.

The viscosity of the sauce shall be sufficient to suspend wet food compositions, in particular chunks, throughout a filling and canning operation to ensure a consistent ratio of such wet food compositions.

In some embodiments, the viscosity of the sauce can be lower than about 20 m Pa·s (millipascal-second) or cP (centipoise).

In some embodiments, the viscosity of the sauce can be from about 1 cP to about 20 cP.

In some embodiments, the viscosity of the sauce can be of about 1 cP, or 2 cP, or 3 cP, or 4 cP, or 5 cP, or 6 cP, or 7 cP, or 8 cP, or 9 cP, or 10 cP, or 11 cP, or 12 cP, or 13 cP, or 14 cP, or 15 cP, or 16 cP, or 17 cP, or 18 cP, or 19 cP or 20 cP.

The viscosity of a wet food composition can be measured using several methods and several equipment's well known by the person skilled in the art.

Generally, viscosity of a fluids represents the resistance of this fluid to deformation, at a given rate.

In the present disclosure, two different types of equipment can be used, whether it is for the sauce (Brookfield Viscometer RVDV, at 20 rpm during 1 minute) or for the meat emulsion (Brookfield Rheometer 2000 at ambient temperature, with increasing rotating speed). For both, the fluid composition is positioned in a container, a rotating spindle will represent the movement inside the fluid. The viscosity is expressed in Pa·s (Pascal·seconds), mPa·s (milli-Pascal·seconds) or cP (centipoise), knowing that 1 cP=1 mPa·s.

In the case of the emulsion measurement (Rheometer), the shear rate will increase when the rotation of the spindle accelerates. Arbitrary selected shear conditions are set for comparative purposes, all compositions being analyzed under similar conditions.

]In particular, the chunk can be combined with a sauce to provide a chunk in sauce. A sauce can be a gravy, a jelly, or any other similar aqueous base.

In some embodiments, a wet food composition as described herein can be a chunk in sauce, in particular a chunk in gravy. In such embodiments, it is preferred that the total weight of psyllium, included in the wet food composition, is wholly included in the formulation of the chunk. Otherwise said, in such embodiments, at the time of preparing such a wet food composition in a form of a chunk in sauce, the sauce composition does not include psyllium.

In some embodiments, a hybrid-type wet food composition can be a wet food composition which can have the texture and the aspect of a loaf-type wet food composition and the shape of a chunk form combined with a sauce. As non-limitative example, the hybrid-type wet food can be a loaf-type wet food incorporating sauce.

In some embodiment, the sauce can be a gravy, a jelly, a sauce, a broth, a bouillon or any other similar aqueous base.

In some embodiments, the wet food composition can be a cat wet food composition.

In some embodiments, the cat wet food composition can be nutritionally complete. In some embodiments, the wet food composition according to the disclosure is palatable for a companion animal such as a canine and/or a feline.

A feline animal can encompass a cheetah, a puma, a jaguar, a leopard, a lion, a lynx, a liger, a tiger, a panther, a bobcat, an ocelot, a smilodon, a caracal, a serval and/or a cat.

In some embodiments, a feline animal can be a cat. A cat can encompass a wild cat and a domestic cat. In some embodiments, a cat can be a domestic cat.

A canine can encompass dogs, wolves, coyotes, foxes or jackals. In some embodiments, a canine can be a dog. A dog can be selected from a recognized dog breed.

A recognized dog breed can encompass, without limitation, an Afghan hound, an Airedale, an akita, an Alaskan malamute, a basset hound, a beagle, a Belgian shepherd, a bloodhound, a border collie, a border terrier, a borzoi, a boxer, a bulldog, a bull terrier, a cairn terrier, a chihuahua, a chow, a cocker spaniel, a collie, a corgi, a dachshund, a dalmatian, a Doberman, an English setter, a fox terrier, a German shepherd, a golden retriever, a great Dane, a greyhound, a griffon Bruxellois, an Irish setter, an Irish wolfhound, a King Charles spaniel, a Labrador retriever, a Lhasa apso, a mastiff, a newfoundland, an old English sheepdog, a Papillion, a Pekingese, a pointer, a Pomeranian, a poodle, a pug, a rottweiler, a St. Bernard, a saluki, a Samoyed, a schnauzer, a Scottish terrier, a Shetland sheepdog, a shih tzu, a Siberian husky, a Skye terrier, a springer spaniel, a West Highland terrier, a whippet and a Yorkshire terrier.

Some of the above listed recognized dog breeds can have further subdivided dog breed.

In some embodiments, the companion animal can be a cat and/or a dog.

### Formulation of the Wet Food Compositions

A specificity of the wet food composition of the disclosure is its high amount of psyllium, as a source of Total Dietary Fibers (TDF), combined with an adapted source of protein, further source of TDF, source of fat and, optionally food additives.

The nutritional content of the wet food composition can include at least protein, fat, soluble fiber, insoluble fiber, Mannan-oligosaccharides (MOS) and Fructo-oligosaccharides (FOS).

According to some embodiments, the present disclosure relates to a nutritionally complete wet food composition for a companion animal including, on a dry matter basis:
from about 15% to about 45% by weight of protein;
from about 5% to about 25% by weight of fat;
from about 6% to about 14% of Total Dietary Fibers (TDF);
wherein at least about 50% by weight of the total amount of TDF originates from psyllium.

In general, a wet food composition as disclosed herein can include protein, fat, TDF, and optionally one or more further ingredients such as carbohydrates, ash, starches, additives, vitamins and/or minerals. The sum of the weight of each of the ingredients comprised therein amounting, on a dry matter basis, to 100% by weight.

### Total Dietary Fibers (TDF)

The wet food composition as described herein includes a source of TDF.

As used herein, the term “fiber”, or “dietary fiber”, or “total dietary fiber”, or “TDF” (for “Total Dietary Fibers”), designates soluble fibers and insoluble fibers.

Soluble fibers can be defined as being resistant to digestion and absorption in the small intestine and undergo complete or partial fermentation in the large intestine by opposition to insoluble fiber that can be defined as non-starch polysaccharides that are resistant to digestion and absorption in the small intestine, and resistant to fermentation in the large intestine. Soluble fibers are considered as having a prebiotic effect by providing short chain fatty acids as a source of energy to colonocytes.

Insoluble fibers are considered as useful for transit and ballast effect.

In some embodiments, a source of TDF can be selected from beet pulp, guar gum, chicory root, psyllium, pectin, blueberry, cranberry, squash, apples, oats, beans, citrus, barley, or peas cellulose, whole wheat products, wheat oat, corn bran, flax seed, grapes, celery, green beans, cauliflower, potato skins, fruit skins, vegetable skins, peanut hulls, soy fiber and a combination thereof.

In some embodiments, a source of fiber can be psyllium, chicory pulp, or cellulose.

In some embodiments, the wet food composition as described herein can include, on a dry matter basis, from about 6% to about 14% by weight of TDF.

In some embodiments, the wet food composition as described herein can include, on a dry matter basis, about 6%, about 7%, about 8%, about 9%, about 10%, about 11%, about 12%, about 13% or about 14% by weight of TDF.

In some embodiments, the wet food composition as described herein can include, on a dry matter basis, from about 7% to about 12%, or from about 7.5% to about 11%, or from about 8% to about 10% by weight of TDF.

In some embodiments, the wet food composition as described herein can include, on a dry matter basis, about 8%, about 8.1%, about 8.2%, about 8.3%, about 8.4%, about 8.5%, about 8.6%, about 8.7%, about 8.8%, about 8.9%, about 9.0%, about 9.1%, about 9.2%, about 9.3%, about 9.4%, about 9.5%, about 9.6%, about 9.7%, about 9.8%, about 9.9%, or about 10% by weight of TDF.

As described in the present disclosure, TDF incorporated in a wet food composition, can include soluble fibers and insoluble fibers. In some embodiments, at least about 50% by weight of the total amount of TDF can consist of soluble fibers. If a wet food composition can include,
on a dry matter basis, about 9% by weight of TDF, therefore when at least about 50% by weight of the total amount of TDF are soluble fibers, then about 4.5% by weight are soluble fibers. In some embodiments, from about 50% to about 70% by weight of the total amount of TDF can consist of soluble fibers, on a dry matter basis.

In some embodiments, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69% or about 70% by weight of the total amount of TDF can consist of soluble fibers, on a dry matter basis.

In some embodiments, from about 55% to about 65% by weight of the total amount of TDF can consist of soluble fibers, on a dry matter basis.

In some embodiments, the wet food composition as described herein can include, on a dry matter basis, from about 4% to about 7% by weight of soluble fibers.

In some embodiments, the wet food composition as described herein can include, on a dry matter basis, about 4%, 4.1%, 4.2%, 4.3%, 4.4%, 4.5%, 4.6%, 4.7%, 4.8%, 4.9%, 5%, 5.1%, 5.2%, 5.3%, 5.4%, 5.5%, 5.6%, 5.7%, 5.8%, 5.9%, 6%, 6.1%, 6.2%, 6.3%, 6.4%, 6.5%, 6.6%, 6.7%, 6.8%, 6.9% or about 7% by weight of soluble fibers.

In some embodiments, the wet food composition as described herein can include, on a dry matter basis, from about 4.5% to about 6%, or from about 5% to about 5.5% by weight of soluble fibers.

In some embodiments, a source of soluble fiber can be selected from beet pulp, guar gum, chicory pulp, chicory root, psyllium, pectin, blueberry, cranberry, squash, apples, oats, beans, citrus, barley, peas, and/or a combination thereof.

In some embodiments, at least about 30% by weight of the total amount of TDF can consist of insoluble fibers.

In certain embodiments, if a wet food composition can include, on a dry matter basis, about 9% by weight of TDF, therefore when at least about 30% of the total amount of TDF are insoluble fibers, then about 2.7% by weight are soluble fibers.

In some embodiments, from about 30% to about 50% by weight of the total amount of TDF can consist of insoluble fibers, on a dry matter basis.

In some embodiments, about 30%, about 31%, about 32%, about 33%, about 34%, about 35%, about 36%, about 37%, about 38%, about 39%, about 40%, about 41%, about 42%, about 43%, about 44%, about 45%, about 46%, about 47, about 48%, about 49% or about 50% by weight of the total amount of TDF can consist of insoluble fibers, on a dry matter basis.

In some embodiments, from about 35% to about 45% by weight of the total amount of TDF can consist of insoluble fibers, on a dry matter basis.

In some embodiments, the wet food composition as described herein can include, on a dry matter basis, from about 2% to about 5% by weight of insoluble fibers.

In some embodiments, the wet food composition as described herein can include, on a dry matter basis, of about 2%, about 2.1%, about 2.2%, about 2.3%, about 2.4%, about 2.5%, about 2.6%, about 2.7%, about 2.8%, about 2.9%, about 3%, about 3.1%, about 3.2%, about 3.3%, about 3.4%, about 3.5%, about 3.6%, about 3.7%, about 3.8%, about 3.9%, about 4%, about 4.1%, about 4.2%, about 4.3%, about 4.4%, about 4.5%, about 4.6%, about 4.7%, about 4.8%, about 4.9%, or about 5% by weight of insoluble fiber.

In some embodiments, the wet composition as described herein can include, on a dry matter basis, from about 2.5% to about 4.5% by weight.

In some embodiments, a source of insoluble fiber can be selected from cellulose, whole wheat products, wheat oat, corn bran, flax seed, grapes, celery, psyllium, green beans, cauliflower, potato skins, fruit skins, vegetable skins, peanut hulls, soy fiber, and/or a combination thereof.

As non-limiting embodiments, the wet food composition as described herein can include, on a dry matter basis, about 9% by weight of TDF, wherein about 60% of the total amount of TDF include soluble fibers and about 40% of the total amount of TDF include insoluble fibers.

As other non-limiting embodiments, the wet food composition as described herein can include, on a dry matter basis, about 5.4% by weight of soluble fibers and about 3.6% by weight of insoluble fibers. In such an embodiment, the wet food composition can include, on a dry matter basis, about 9% by weight of TDF.

In some embodiments, the weight ratio of soluble fiber to insoluble fiber can be from about 1:1 to about 2:1, preferentially from about 1.2:1 to about 1.5:1.

A wet food composition as described herein can include Mannan oligosaccharides (MOS) and/or Fructo oligosaccharides (FOS). Mannan oligosaccharides (MOS) and Fructo oligosaccharides (FOS) are parts of TDF.

As used herein, “Mannan oligosaccharides” or “MOS” are non-digestible short-chain branched carbohydrates composed of up to 10 mannose units linked via α-(1,3) and α-(1,6) bonds. In general, MOS can be primarily produced from the cell walls of yeasts, for example, Saccharomyces cerevisiae.

In some embodiments, the wet food composition can include, on a dry matter basis, from about 0.01% to about 1% by weight of MOS, from about 0.025% to about 0.09%, or particularly from about 0.05% to about 0.08% by weight of MOS. In some embodiments, the wet food composition can include, on a dry matter basis, about 0.055% by weight of MOS.

In some embodiments, the wet food composition can include, on a dry matter basis, about 0.01%, about 0.02%, about 0.03%, about 0.04%, about 0.05%, about 0.06%, about 0.07%, about 0.08%, about 0.09%, about 0.1%, about 0.2%, about 0.3%, about 0.4%, about 0.5%, about 0.6%, about 0.7%, about 0.8%, about 0.9% or about 1% by weight of MOS.

As used herein, “Fructo oligosaccharides” or “FOS” are non-digestible short-chain branched carbohydrates composed of glucose and fructose. In general, FOS can be primarily produced by hydrolysis of inulin.

In some embodiments, the wet food composition can include, on a dry matter basis, from about 0.01% to about 1%, by weight of FOS.

In some embodiments, the wet food composition can include, on a dry matter basis, from about 0.15% to about 0.8%, or from about 0.15% to about 0.4%, by weight of FOS.

In some embodiments, the wet food composition can include, on a dry matter basis, about 0.38% by weight of FOS.

In some embodiments, the wet food composition can include, on a dry matter basis, about 0.15%, about 0.2%, about 0.25%, about 0.3%, about 0.35% or about 0.4% by weight of FOS.

### Psyllium

A wet food composition as described herein contains a high amount of psyllium, specifically as a source of Total Dietary Fibers (TDF). Psyllium is a small seed surrounded by a husk produced by plants of the genus Plantago, principally Plantago ovata and Plantago afra. Psyllium is very rich in soluble and insoluble fibers. Generally, psyllium can consist of at least 85% of fibers.

Fiber part of psyllium may be composed of about 65% by weight of cellulose, hemicellulose and lignin and about 35% by weight of gums, pectins and mucilage, on a dry matter basis. Fibers are found mainly in the husk of the psyllium.

In some embodiments, psyllium can include psyllium seeds, psyllium husks and/or psyllium seeds and husks. In some embodiments, psyllium can consist of psyllium husk.

In some embodiments, psyllium can represent a source of TDF which can provide at least about 50% of the total weight of TDF, on a dry matter basis.

In some embodiments, psyllium can represent a source of TDF which can provide at least about 70% of the total weight of TDF, on a dry matter basis.

In some embodiments, psyllium can represent a source of TDF which can provide from about 50% to about 100% of the total weight of TDF, from about 60% to about 100% of the total weight of TDF, from about 70% to about 100% of the total weight of TDF, from about 70% to about 90% of the total weight of TDF, from about 70% to about 85% of the total weight of TDF, or from about 70% to about 80% of the total weight of TDF, on a dry matter basis.

In some embodiments, psyllium can represent a source of TDF which can provide about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, or about 85% of the total weight of TDF, on a dry matter basis.

In some embodiments, the wet food composition can include, on a dry matter basis, at least about 5% by weight of psyllium. In some embodiments, the wet food composition can include, on a dry matter basis, from about 5% to about 12% by weight of psyllium.

In some embodiments, the wet food composition can include, on a dry matter basis, from about 5% to about 8% by weight of psyllium.

In some embodiments, the wet food composition can include, on a dry matter basis, of about 5%, about 5.1%, about 5.2%, about 5.3%, about 5.4%, about 5.5%, about 5.6%, about 5.7%, about 5.8%, about 5.9%, about 6%, about 6.1%, about 6.2%, about 6.3%, about 6.4%, about 6.5%, about 6.6%, about 6.7%, about 6.8%, about 6.9%, about 7%, about 7.1%, about 7.2%, about 7.3%, about 7.4%, about 7.5%, about 7.6%, about 7.7%, about 7.8%, about 7.9%, or about 8% by weight of psyllium.

In some embodiments of a wet food composition in a form of a chunk in sauce, in particular a chunk in gravy, the chunk can include the total weight of psyllium meant to be included in the wet food composition at the step of manufacturing.

Generally, a relatively high amount of psyllium can be recommended in the management of constipation in companion animals. In particular, an amount of at least about 5% by weight of psyllium, on dry matter basis, can allow a well-balanced intestinal transit of the companion animal and can avoid constipation.

In addition, a relatively high amount of at least about 5% by weight of psyllium, on a dry matter basis, can result in an increased fecal moisture, which represents a real benefit and advantage to promote regulation/resolution of the constipation.

### Protein

In some embodiments, the wet food composition as described herein can include an amount of protein. Accordingly, the protein level shall be high enough to ensure maintenance of lean body mass while maintaining a right texture and palatability of the wet food composition for the companion animals.

In some embodiments, a wet food composition can include, on a dry matter basis, from about 15% to about 45%, by weight of protein.

In some embodiments, a wet food composition can include, on a dry matter basis, from about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, or about 45% by weight of protein.

In some embodiments, a wet food composition can include, on a dry matter basis, from about 15% to about 45%, or from about 30% to about 45%, or from about 33% to about 43% by weight of protein.

In some embodiments, the wet food composition can include a plurality of proteins that are contained in a protein source which is used in the manufacture process of the wet food composition.

In some embodiments, the proteins can be non-hydrolyzed protein. In some embodiments, the proteins can be hydrolyzed protein.

Hydrolyzed protein can be partly hydrolyzed, or even wholly hydrolyzed to give a hydrolyzed protein having a molecular weight of about 100 dalton to about 50,000 dalton.

In some embodiments, hydrolyzed protein can include about 30% to 95% of proteins that has a molecular weight of about 100 dalton to about 50,000 dalton, or about 500 dalton to about 40,000 dalton, or about 1,000 dalton to about 30,000 dalton, or about 2,000 dalton to about 20,000 dalton, about 2,000 dalton to about 15,000 dalton.

In some embodiments, hydrolyzed protein can include about 30% or more, or 40% or more, or 50% or more, or 60% or more, or 70% or more, or 80% or more of proteins that has a molecular weight of about 50,000 dalton or less, or 40,000 dalton or less, or 30,000 dalton or less, or 20,000 dalton or less, or 15,000 dalton or less, or 11,000 dalton or less, 10,000 dalton or less, 9,000 dalton or less, 8,000 dalton or less, 7,000 dalton or less, 6,000 dalton or less, 5,000 dalton or less, 4,000 dalton or less, or 3,000 dalton or less, or 2,000 dalton or less, or 1,000 dalton or less, or 500 dalton or less, 200 dalton or less, or 100 dalton or less, based on the total weight of hydrolyzed protein.

A wholly hydrolyzed protein can include at least about 95%, 96%, 97%, 98%, 99% or 100% of hydrolyzed proteins that has a molecular weight of about 11,000 dalton or less.

In some embodiments, a wet food composition of the present disclosure, on a dry matter basis, can comprise from about 60% to about 90% by weight of a source of protein.

In some embodiments, a wet food composition of the present disclosure, on a dry matter basis, can comprise from about 60% to about 90% by weight, or from about 65% to about 90%, or from about 70% to about 90%, or from about 75% to about 90% by weight of a source of protein.

In some embodiments, a wet food composition of the present disclosure, on a dry matter basis, can comprise about 75%, about 76%, about 77%, about 78%, about 79% about 80%, about 81%, about 82%, about 83%, about 84%, about 85%, about 86%, about 87%, about 88%, about 89% or about 90% by weight of a source of protein.

A component/ingredient that can provide a protein source to the wet food composition can originate from an animal source and/or a vegetal source. In some embodiments, a protein source can be a mixture of one or more animal protein source. In some embodiments, a protein source can be a mixture of one or more vegetable protein source. In some embodiments, a protein source can be a mixture of at least one or more animal protein source and at least one or more vegetable protein source.

A source of protein in a non-transformed form can also provide to the wet food composition a source of water, a source of fat, a source of minerals, a source of fibers, and/or a source of vitamins. The nutritional composition of the source of protein depending on the quality and the specificity of the source of protein. An animal source of protein can also provide an amount of fat. A vegetable source of protein can also provide an amount of fiber.

An animal source can be selected, without limitation, from chicken meals, chicken, chicken by-product, lamb, lamb meals, pork, turkey, turkey meals, beef, beef by-products, white fish, venison or a combination thereof.

A vegetable source can be selected, without limitation, from soybean meal, soy protein isolate, soy protein concentrate, maize gluten, milk proteins, gluten, tofu, green lentils, carrot, potato, beets, corn gluten meal, corn protein concentrate or a combination thereof.

Generally, a protein source can be selected from chicken meals, chicken, chicken by-product, lamb, lamb meals, pork, turkey, turkey meals, beef, beef by-products, white fish, venison, soybean meal, soy protein isolate, soy protein concentrate, maize gluten, milk proteins, gluten, tofu, green lentils, carrot, potato, beets, corn gluten meal, corn protein concentrate or a combination thereof.

In particular, one or more protein sources can be combined by the skilled person in order to achieve preferable product texture and appearance, as the proteins may act as the “skeleton” to set the emulsion after cooking. Protein sources can have various textural properties, from highly binding behavior to low binding behavior.

In some embodiments, an animal protein source can be a mixture of highly binding protein source and/or low binding protein source.

In some embodiments, a highly binding protein source can be selected, without limitation, from liver, heart, neck, plasma, carcasses or a combination thereof. A highly binding protein source can originate from an animal source or a mixture of at least two different animal sources such as chicken, lamb, pork, turkey or beef. In some embodiments, a highly binding protein source can be a mixture of liver from chicken, pork, or a combination of chicken liver and pork liver.

In some embodiments, a low binding protein source can be selected, without limitation, from lung, mechanically deboned meat, viscera, entrails, hydrolyzed meat or a combination thereof. A low binding protein source can originate from a meat source or a mixture of at least two different animal sources such as chicken, lamb, pork, turkey or beef. In some embodiments, a low binding protein source can be a mixture of lung from chicken, pork or a combination of chicken liver and pork liver.

In some other embodiments, an animal protein source can be a mixture of lung and liver from chicken, lamb, pork, turkey, beef or a combination thereof. In some embodiments, an animal protein source can be a mixture of lung and liver from chicken and/or pork.

In some embodiments, the weight ratio of highly binding protein source to low binding protein source can be from about 0.5:2 to about 2:0.5. The weight ratio of highly binding protein source to low binding protein source can be of about 0.5:2, or about 0.75:1.5, or about 1:1, or about 1.5:0.75, or about 2:0.5, in particular of about 1:1.

Protein content of a wet food composition can be determined by any methods known by those of skill in the art.

### Fat

In some embodiments, the wet food composition as described herein can include fat. Accordingly, the fat level shall be enough to ensure maintenance of lean body mass while maintaining a right texture and palatability of the wet food composition for the companion animals.

The expression “fat” or “crude fat” as used herein can include any food-acceptable crude fat(s) and/or oil(s) irrespective of their consistency at room temperature.

Fat in a wet food composition as described herein can encompass the total amount of digestible, partially digestible and nondigestible fats or oils that are present in the embodiments of the present disclosure.

Fat can be present in essentially fluid form or in essentially solid form. In some embodiments, the wet food composition can include fat from an animal source and/or a vegetable source.

In some embodiments, a vegetable source providing fat can include, without limitation, wheat, sunflower, safflower, rapeseed, olive, borage, flaxseed, peanuts, blackcurrant seed, cottonseed, wheat, germ, corn germ as well as oils derived from these and combinations thereof.

In some embodiments, an animal source providing fat can include, without limitation, chicken crude fat, turkey crude fat, beef crude fat, duck crude fat, pork crude fat, lamb crude fat, fish oil or any meat, meat by-products, seafood, fish by-products, dairy, eggs or a combination thereof.

Fat can be supplied by any sources known by the person skilled in the art.

In some embodiments, a wet food composition can include, on a dry matter basis, from about 5% to about 25% by weight of fat.

In some embodiments, a wet food composition can include, on a dry matter basis, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, or about 25% by weight of fat.

In some embodiments, a wet food composition can include, on a dry matter basis, from about 5% to about 25%, particularly from about 10% to about 25%, and more particularly from about 15% to about 20% by weight of fat.

Fat content of a wet food composition can be determined by any methods known by the person of skill in the art.

### Other Ingredients

A wet food composition of the present disclosure can further include other ingredients/components which can contribute to the nutritional properties and/or the organoleptic properties of the wet food composition.

In some embodiments, a wet food composition can include corn starch, ash, flavors, preservatives, minerals, trace elements, amino acids and/or coloring.

In some embodiments, the wet food composition can further include, on a dry matter basis, from about 15% to about 45%, from about 15% to about 30%, from about 30% to about 45%, or from about 20% to about 35% by weight of starch.

In some embodiments, the wet food composition can further include, on a dry matter basis, about 15%, about 20%, about 25%, about 30%, about 35%, about 40%, or about 45% by weight of starch.

In some embodiments, starch can include modified starch, pre-gelatinized starch, wheat starch, potatoes starch, rice starch, cassava starch, corn starch and/or a combination thereof. In some embodiments, starch can include corn starch.

In particular embodiments, the wet food composition can further include ash. In some embodiments, the wet food composition can further include, on a dry matter basis, from about 6% to about 12%, from about 8% to about 11%, or from about 9% to about 10% by weight of ash.

In some embodiments, the wet food composition can further include, on a dry matter basis, about 6%, about 7%, about 8%, about 9%, about 10%, about 11% or about 12% by weight of ash.

In some embodiments, the wet food composition can further include, on a dry matter basis, from about 8% to about 11% by weight of ash.

In some embodiments, ash can include Sodium Tripolyphosphate (STPP) and/or an equivalent ingredient. In some embodiments, the wet food composition can include, as part of ash, on a dry matter basis, from about 0.5% to about 1.5% by weight of Sodium Tripolyphosphate (STPP) and/or an equivalent ingredient.

In some embodiments, the wet food composition can include, as part of ash, on a dry matter basis, about 0.5%, about 0.6%, about 0.7%, about 0.8%, about 0.9%, about 1%, about 1.1%, about 1.2%, about 1.3%, about 1.4% or about 1.5% by weight of Sodium Tripolyphosphate (STPP) and/or an equivalent ingredient.

An equivalent of STPP can include dicalcium phosphate and/or monopotassium phosphate.

Sodium Tripolyphosphate (STPP) or an equivalent ingredient can act as emulsifier/texturizer.

In some embodiments, the wet food composition can further include at least one flavor, particularly a natural flavor. In some embodiments, the wet food composition can include, on a dry matter basis, from about 0.1% to about 2% by weight of flavor.

In some embodiments, the wet food composition can include, on a dry matter basis, about 0.1%, about 0.2%, about 0.3%, about 0.4%, about 0.5%, about 0.6%, about 0.7%, about 0.8%, about 0.9%, about 1%, about 1.1%, about 1.2%, about 0.3%, about 1.4%, about 1.5%, about 1.6%, about 1.7%, about 1.8%, about 1.9%, or about 2% by weight of flavor.

In some embodiments, the wet food composition can also include preservatives, minerals, trace elements, and/or coloring.

Table 1 below provides an example of a wet food composition according to the disclosure.

Table 1: Illustrative nutritionally complete cat wet food composition in the form of a chunk in sauce (1.A) or a loaf (1.B) according to the present disclosure.

1.A: WET FOOD COMPOSITION (CHUNK IN SAUCE)

| | Weight % based on the | Weight % based on a dry |
|---|---|---|
| | total weight of the wet food | matter basis of the wet food |
| | composition (as fed) | composition |
| Moisture | 82.2 | — |
| Protein | 7.0 | 39.4 |
| Fat | 2.9 | 16.5 |
| Ash | 1.7 | 9.5 |
| STPP | 0.15 | 0.84 |
| TDF | 1.55 | 8.7 |
| FOS | 0.068 | 0.38 |
| MOS | 0.01 | 0.056 |
| Psyllium husk | 1.2 | 6.7 |
| Other | 4.65 | 25.9 |
| Starch | 3.6 | 20.4 |
| Total | 100 | 100 |

In particular, the sauce, of the wet food composition in table 1.A can be prepared by combining, based on the total weight of the gravy, about 1% by weight of corn starch, about 1.2% by weight of other elements (flavoring, coloring, etc.) with the required amount of water to reach 100% by weight, such as about 97.8% by weight of water.

1.B: WET FOOD COMPOSITION (LOAF)

| | Weight % based on the | |
|---|---|---|
| | total weight of the wet | Weight % on a dry |
| | food composition (as | matter basis of the wet |
| | fed) | food composition |
| Moisture | 81.8 | — |
| Protein | 7.6 | 41.5 |
| Fat | 2.9 | 15.9 |
| Ash | 1.8 | 9.9 |
| STPP | 0.2 | 1.1 |
| TDF | 1.7 | 9.2 |
| FOS | 0.035 | 0.2 |
| MOS | 0.01 | 0.055 |
| Psyllium husk | 1.1 | 6.1 |
| Other | 4.2 | 23.5 |
| Starch | 3.4 | 19.1 |
| Total | 100 | 100 |

The moisture content (% w/w) represents the content of liquid, in particular of aqueous content, more particularly the water content of the food composition.

Components/ingredients of the chunk in sauce (1.A) or a loaf (1.B) comprises, without limitation, water, lung and liver from chicken and/or pork, psyllium husk, cellulose, zeolite, sodium tripolyphosphate, FOS, MOS, cereals (flours), vitamins, minerals, fatty acids and flavouring.

### Method of Manufacturing

The present disclosure also relates to a method for manufacturing a wet food composition as described herein. In some embodiments, one or more dry ingredients can be mixed with one or more wet ingredients to form an emulsion or dough. The emulsion or dough can be heated under pressure to a predetermined temperature and gradually cooled, and subsequently introduced into a processing zone. In the processing zone, the emulsion can be subjected to a predetermined pressure and discharged. The extrudate can be segmented into pieces in a desired shape.

In some embodiments, a method of manufacturing a wet food composition can include at least the steps of:
(a) mixing a plurality of ingredients in such a way to obtain a final mixture including at least, on a dry matter basis from about 6% to about 14% by weight of TDF, wherein at least about 50% of the total amount of TDF originates from psyllium, from about 15% to about 45% by weight of protein, and from about 5% to about 25% by weight of fat,
(b) heating the mixture obtained at step (a), and
(c) optionally, combining the mixture obtain at step (b) with an aqueous composition as described herein.

As described herein, an aqueous composition can be a sauce. In such embodiments the sauce can be mixed with the mixture cooled or still hot, sealed in a container, retorted, and cooled to produce a wet food composition in a sauce.

In some embodiments, the plurality of ingredients of step (a) can further include one or more of, on a dry matter basis, from about 15% to about 45% of starch, from about 6% to about 12% of ash, from about 0.01% to about 1% of MOS, and from about 0.01% to about 1% of FOS.

In some embodiments, the plurality of ingredients of step (a) can further include one or more of the following ingredients: preservative, vitamin, mineral, flavoring, trace element, additive and/or coloring.

A person of ordinary skill in the art will appreciate a wide variety of methods of manufacturing a wet food composition which is suitable for use with the present disclosure.

### Uses and Methods

The present disclosure also relates to the use of a wet food composition as described herein for managing an intestinal disorder in a companion animal.

Otherwise said, the present disclosure also relates to a method for managing an intestinal disorder in a companion animal in need thereof including a step of administering a wet food composition as described herein to the companion animal.

In some embodiments, the present disclosure also relates to a nutritionally complete wet food composition as described herein for use in a method for preventing and/or treating an intestinal disorder in a companion animal in need thereof.

In some embodiments, an intestinal disorder can be selected among constipation, colitis, intestinal dysmotility, megacolon, acute colitis, chronic colitis, chronic enteropathy, chronic idiopathic large bowel disease, dysautonomia, obstipation and/or anal incontinence.

In some embodiments, an intestinal disorder can be constipation. As used herein, “constipation” refers to a condition which can occur when the passage of the stools is difficult through the large intestine and the stool expulsion is infrequent and, eventually, difficult and painful for the companion animal. Constipation can be seen as a primary gastrointestinal disease (such as intestinal dysmotility), or as a secondary symptom of a different primary underlying disease.

Generally, a companion animal can be considered as constipated when (i) a more intense effort of the animal is furnished to defecate than usual, (ii) the stool consistency of the animal is dry/hard, and/or (iii) the frequency of stool expulsion of the animal is reduced. In some embodiments, a companion animal can be considered as constipated when the frequency of stool expulsion by the animal occurs 3 times per week or less, or 2 times per week or less, or 1 time per week or less. In some embodiments, a companion animal can be considered as constipated when the frequency of stool expulsion by the animal occurs 4 times per week or less, or 3 times per week or less, or 2 times per week or less, or 1 time per week or less.

In some embodiments, constipation can be chronic constipation or acute constipation. Chronic constipation can be defined as constipation wherein by a straining to defecate, hard dry stools and/or reduced frequency for the stool expulsion by the companion animal, such as a reduction of 50% compared to the reported average for said companion animal. As a non-limitative example, a companion animal can present chronic constipation when the stool expulsion occurs 3 times per week or less for at least 3 weeks or 4 weeks or 5 weeks in a row.

Acute constipation can be defined as constipation wherein stool expulsion by the companion animal occurs 3 times per week or less for one week, or 2 times per week or less for one week. Generally, a companion animal can present acute constipation when the stool expulsion occurs 3 times or less one week per month. A companion animal can present acute constipation when the stool expulsion occurs 2 times or less one week per month.

In some embodiments, a wet food composition as described herein can be provided to a companion animal in need thereof on a daily basis. In some embodiments, a wet food composition as disclosed herein can be provided to the companion animal in need thereof as the sole food composition during the period of management. In some embodiments, a wet food composition as described herein can be provided to the companion animal in need thereof in alternation with an additional food composition.

In some embodiments, the additional food composition can be a nutritionally complete food composition.

The additional food composition can be selected from food compositions in the art, including the large variety of commercialized food compositions adapted to the companion animal in need thereof.

In some embodiments, a wet food composition as described herein can be provided every other day to the companion animal in need thereof, the additional food composition being provided the other day.

In some embodiments, a wet food composition as described herein can be provided according to a time schedule of every three, four, five, six or seven days on a week.

In some embodiments, the beneficial effects of managing an intestinal disorder, and especially constipation, can be provided when the animal can be fed with the wet food composition described herein every day in a week per month.

Without wishing to be bound by any particular theory, an efficient management of an intestinal disorder, can require that the companion animal, such as a cat, is provided with a wet food composition as described herein at least one time, two times, or three times on a daily basis.

The period of feeding with a wet food composition as described herein can range from several weeks to several years, depending notably on the severity of the intestinal disorder.

In some embodiments, the wet food composition can be provided to the companion animal in need thereof during a longer period of time, such as during a period of time of 12 months or more, such as of 18 months of more, or such as 24 months or more, either (i) according to a feeding schedule comprising providing to the companion animal exclusively the wet food composition as described herein or (ii) according to a schedule alternating the wet food composition described herein and an additional corresponding dry food composition.

In some embodiments, the companion animal can be provided with a wet food composition as described herein for a longer period, such as two years or more. In some embodiments, the companion animal can be provided with a wet food composition described herein for the whole lifetime of the said companion animal.

The uses and methods of the present disclosure do not affect the appetite of the companion animal in need thereof. The uses and methods of the present disclosure do not affect the body weight of the companion animal in need thereof.

The methods of the present disclosure can further include a step of making a feeding recommendation that includes a wet food composition as described herein.

Without wishing to be bound by any particular theory, an efficient management of an intestinal disorder can occur when an amelioration of the frequency of the stool has occurred. In particular, an amelioration of the condition of the companion animal can occur when the stool expulsion occurs 7 times per week or more, or 8 times per week or more, or 10 times per week or more.

Without wishing to be bound by any particular theory, an efficient management of an intestinal disorder can occur when the stool consistency presents a score of about 2.5, specifically of 2.0 to 3.5, on a 5-point scale, based on the WALTHAM® Feces scoring system.

Without wishing to be bound by any particular theory, an efficient management of an intestinal disorder can occur when an amelioration of the effort of the animal to defecate is seen or the effort to defecate returns to normal.

### EXAMPLES

This disclosure can be further illustrated by the following examples of particular embodiments thereof, although it will be understood that these examples are included merely for purposes of illustration and are not intended to limit the scope of the disclosure.

### Example 1

The texture and the aspect of the wet food composition of the disclosure, has been proceeded to a palatability test with cats.

### A. Material & Methods

The palatability of the wet food composition was determined using a “Two Bowl Test”. This test allows to determine the palatability of a food regarding the food preference of the cat between two different food compositions.

In this test, 29 cats were enrolled. A test wet food composition, corresponding to the food compositions of the disclosure, and a control wet food composition were placed in their respective bowls and presented simultaneously to each cat. The bowls were left with the cat for 20 minutes. The amount of food composition offered in each bowl was sufficient for the animals' daily caloric intake. The test was performed in the morning at 7:00 am and again at 11 am. The remaining food composition was collected and weighed to determine how much of each food composition was consumed by the cat. A test with a crossover design was used in order to ensure that all the food compositions are tested on each cat. Each food composition was classified alongside the others as a function of its consumption.

Thus, the possible results are either the preference for the wet food composition of the disclosure, the preference for the control wet food composition or no preference. The first choice of the cats was also observed.

The test wet food composition (Food composition A) and the control wet food composition (Food composition B) were in a form of a chunk in gravy.

The test wet food composition (Food composition A) corresponds to the chunk in sauce as described above in Table 1.A.

The chunk was prepared by combining ingredients, in a suitable container. The ingredients were mixed using any suitable mixing device to provide a substantially homogenous mixture, obtaining chunks.

The gravy was prepared by combining corn starch (about 1% by weight), coloring (about 0.02% by weight) and flavoring elements (about 1.2% by weight), weight percentage of corn starch, coloring and flavoring based on the total weight of the gravy, with the required amount of water in a suitable container and mixing, e.g., using a high-shear mixer, until a substantially homogenous mixture is obtained.

The obtained chunks were combined with the gravy in a chunks:gravy ratio of 0.8:1 (such as about 47% of chunk for about 53% of gravy).

Chunk in gravy composition can be prepared with at least two methods such as:
i) “one step filling”: in this method, chunks are mixed with gravy in a mixing tank, by means of a single, double, or planetary mixer with a paddle attachment, then the obtained preparation is dosed into packaging, or
ii) “two-step filling”: in this method, chunks are firstly dosed directly into a packaging, preferably through multi-head weigher, then gravy is added into the pre-filled packaging (respecting the preset chunk:gravy ratio).

The control wet food composition (Food composition B) corresponds to “Hill's Prescription GI Biome Digestive Wet Cat Food/Fiber Care Chicken & Vegetable Stew”, having the composition of Table 2.

TABLE 2
(67 kcal/2.9 oz (82 g) can)

| | Weight % based on a dry | |
|---|---|---|
| NUTRITIONAL | matter basis of the control | |
| ANALYSIS | wet food composition | |
| Protein | 37.4 | |
| Fat | 19.1 | |
| Carbohydrate/NFE | 32.5 | |
| Crude Fiber | 4.8 | |
| Calcium | 0.96 | |
| Phosphorus | 0.65 | |
| Potassium | 1.02 | |
| Sodium | 0.4 | |
| Magnesium | 0.067 | |
| Taurine | 0.46 | |
| Vitamin C | 170 | ppm |
| Vitamin E | 740 | IU/kg |

| | |
|---|---|
| Total Omega-3 FA | 1.3 |
| Total Omega-6 FA | 3.48 |

Ingredients: Chicken Broth, Chicken, Pork Liver, Carrots, Rice Starch, Wheat Gluten, Spinach, Ground Pecan Shells, Rice, Chicken Liver Flavor, Flaxseed, Soybean Oil, Potassium Alginate, Whole Grain Barley, Dried Citrus Pulp, Fish Oil, Dried Beet Pulp, Calcium Chloride, L-Lysine, Natural Flavor, Pumpkin, Pressed Cranberries, Powdered Cellulose, Guar Gum, Dicalcium Phosphate, Choline Chloride, Oat Fiber, Potassium Citrate, Sodium Tripolyphosphate, Fructooligosaccharides (FOS), Calcium Lactate, Calcium Gluconate, vitamins (Vitamin E Supplement, Thiamine Mononitrate, L-Ascorbyl-2-Polyphosphate (source of Vitamin C), Niacin Supplement, Menadione Sodium Bisulfite Complex (source of Vitamin K), Pyridoxine Hydrochloride, Calcium Pantothenate, Vitamin B12 Supplement, Riboflavin Supplement, Biotin, Folic Acid, Vitamin D3 Supplement), Taurine, Psyllium Seed Husk, minerals (Zinc Oxide, Ferrous Sulfate, Manganese Sulfate, Copper Sulfate, Calcium Iodate).

### B. Results

### a. Two Bowl Test

As shown in Table 3, there is a significant preference for the test food composition A (chunk in gravy) than the food composition B (control Hill's food composition).

TABLE 3
Results

| Mean food composition A (g) | 45.19 | Ratio A | 58.57% |
|---|---|---|---|
| | | (%) | |
| Mean food composition B (g) | 30.66 | Ratio B | 41.43% |
| | | (%) | |
| Significance of the difference | 0.109218 (NS) | | |
| between A and B | | | |
| Preference | A: 45%/B: 17%/NC: 38% | | |
| Preference probability | 0.012419 (S) | | |
| First Choice | A: 75%/B: 25% | | |
| Probability First Choice | 0.000355 (THS) | | |

Therefore, it flows from these results (Table 3) that the palatability and appearance of the test wet food composition A, including a high amount of psyllium, was more appreciated by the cats than the control food composition B.

### b. Texture Assay

The aspect and texture of food compositions have been evaluated, initially to determine the most suitable gravy formula (compositions J and K), and then to work on the most adequate chunk emulsion formulation (compositions X and Y). A loaf emulsion was also studied (composition Z, no gravy needed).

The viscosity was measured using a Brookfield RVDV viscometer for the gravy, and a Brookfield Rheometer 2000 for the emulsion.

Generally, the gravy should present a viscosity of 20 cP or less for both flowability within process and coating properties over the chunks. A maximum gravy viscosity could reach 250 cP but not over this value.

The compositions of gravy J and gravy K are detailed in Table 4.

TABLE 4
Compositions of gravy J and K

| | Weight % BY WEIGHT of the | |
|---|---|---|
| | aqueous composition (Gravy) | |
| | Gravy recipe J | Gravy recipe K |
| Water % | 97.8 | 93.5 |
| Corn starch % | 1 | 2 |
| Psyllium husk % | 0 | 2.3 |
| Other ingredients (flavourings, | 1.2 | 2.2 |
| colorings etc) % | | |
| Total | 100.0 | 100.0 |

TABLE 5
Gravy viscosity results

| | | pH and | | Brookfield RVDV-@ | | |
|---|---|---|---|---|---|---|
| | | Thermometer | | 20 rpm/1 minute | | |
| | | | Temperature | Viscosity | Spindle | Torque |
| Gravy | Processability | pH | (° C.) | (cP) | No. | (%) |
| Gravy J | VALIDATED | 7.09 | 31 | 7 | 1 | 1.3 |
| Gravy K | REJECTED | 6.68 | 32 | 7,400 | 6 | 15 |

As shown in Table 5, gravy composition J without psyllium, presents a viscosity of less than 20 cP and was validated for both processability and final aesthetics (coating over the chunks), whereas gravy composition K, which comprises psyllium, presents a viscosity substantially more than 20 cP or even 250 cP, resulting in a gravy which could hardly be processed and gave a very solidified aspect to the final preparation.

Gravy composition J was then selected for further formula development, hence without psyllium: this meant that psyllium was to be fully added in the chunk emulsion composition.

Three emulsions formulas were assessed: the one corresponding to a chunk composition without gravy stated in Table 1.A is recipe Y, the one corresponding to loaf composition stated in Table 1.B is recipe Z, and the last recipe X corresponds to slight alterations of recipe Y, as the impact of psyllium addition into the emulsion was hard to predict in advance. Chunk compositions are meant to be completed by gravy compositions before being packed, while loaf compositions are final and are directly packed.

Recipe X and Y correspond to chunk compositions detailed in the following table 6:

TABLE 6
Chunk compositions

| | Weight % of the | Weight % of the |
|---|---|---|
| | meat emulsion X | meat emulsion Y |
| Ingredients | (chunk) as fed | (chunk) as fed |
| Water | 2.1 | 3.5 |
| Meats and animal by-products | 82.8 | 81.5 |
| (chicken and/or pork) | | |
| Psyllium husk | 2.55 | 2.55 |
| Cellulose purified | 0.43 | 0.43 |
| Zeolite | 0.38 | 0.38 |
| Sodium tripolyphosphate (STPP) | 0.43 | 0.32 |
| FOS | 0.15 | 0.15 |
| MOS | 0.09 | 0.09 |
| Cereals (flours) | 8.3 | 8.3 |
| Other ingredients for nutritional | 2.78 | 2.78 |
| purpose (fatty acids, vitamins, | | |
| minerals) and flavouring | | |

Meats and animal by-products generally include water, proteins, fats, minerals (iron and/or zinc) and/or vitamins (vitamins B12).

TABLE 7
Emulsion viscosity results of chunk (without gravy) or loaf

| | | | Brookfield Rheometer |
|---|---|---|---|
| | pH and Thermometer | | 2000 |
| EMULSION | | Temperature | Viscosity at selected |
| Emulsion | pH | (° C.) | shear rate (cP) |
| Recipe X (chunk) | 6.52 | 23.4 | 146,354 |
| Recipe Y (chunk) | 6.61 | 24.1 | 132,885 |
| Recipe Z (loaf) | 6.81 | 21.8 | 9,582 |

An arbitrary shear rate area (unit in s⁻¹) is selected in order to compare various compositions. All measurements are run under similar conditions (Table 7).

Line operators are used to evaluate the processability of the compositions on their line, which can be related to viscosity values. The most appropriate values are dependent on the production process set up. For chunk-making process, under the present conditions set up, the most appropriate viscosity values are ranging from about 80,000 to about 132,000 cP at selected shear rate area. For loaf process, the most appropriate viscosity values are less definite, since the temperature increase of the emulsion will impact the viscosity: by adapting the temperature values, the line operators can ensure processability and especially filling step into final container. Generally speaking, loafs with viscosity at selected shear rate below 15,000 cP are appropriate for current processing conditions.

Recipe X and Y include different combinations of ingredients while maintaining the same nutritional quality, especially protein sources, fiber sources, fat sources and other texturizing agents. Protein and fat sources, such as animal meats, are considered to be important for obtaining a suitable texture for the final wet food composition. Because final textural properties are only visible after cooking and hard to foresee with precisions, several iterations are usually needed in order to achieve the right consistency for both product aesthetics and processability on the line.

Thus, while in the present process conditions the viscosity value of recipe X is higher than the upper limit of the range of the most appropriate viscosity values to be processed, it does not mean that recipe X cannot be appropriate to be processed under other manufacturing processes. Considering other manufacturing processes, the range of the most appropriate viscosity values of a wet food composition can reasonably extend from about 80,000 to about 150,000 cP.

### C. Conclusion

The present examples demonstrate that a high amount of psyllium, of about 6% to 7% by weight, in a wet food composition can impact the texture and aesthetics of the food composition. When overall formula balance is adapted accordingly, it is possible to obtain a wet food composition with the aesthetics expected by consumers, while maintaining the organoleptic properties of wet food compositions and being able to be used in the context of intestinal disorders in companion animals.

1. A nutritionally complete wet food composition for a companion animal having an intestinal disorder comprising, on a dry matter basis:
i) from about 15% to about 45% by weight of protein;
ii) from about 5% to about 25% by weight of fat;
iii) from about 6% to about 14% by weight of Total Dietary Fibers (TDF);
wherein at least about 50% by weight of the total amount of TDF, on a dry matter basis, originates from psyllium.

2. The wet food composition according to claim 1, wherein the wet food composition comprise, from about 5% to about 12% by weight of psyllium, on a dry matter basis.

3. The wet food composition according to claim 1, wherein from about 50% to about 70% by weight of the total amount of TDF consists of soluble fibers, on a dry matter basis.

4. The wet food composition according to claim 1, wherein from about 30% to about 50% by weight of the total amount of TDF consists of insoluble fibers, on a dry matter basis.

5. The wet food composition of claim 1, wherein the wet food composition comprises a weight ratio of soluble fiber to insoluble fiber of from about 1:1 to about 2:1.

6. The wet food composition of claim 1, wherein the moisture content is from about 30% to about 90% by weight of the wet food composition.

7. The wet food composition of claim 1, wherein the wet food composition comprises from about 6% to about 12% by weight of ash, on a dry matter basis.

8. The wet food composition of claim 1, wherein the wet food composition comprises from about 15% to about 45% by weight of starch, on a dry matter basis.

9. The wet food composition of claim 1, wherein the wet food composition comprises from about 0.01% to about 1% by weight of Mannan-oligosaccharides (MOS), on a dry matter basis.

10. The wet food composition of claim 1, wherein the wet food composition comprises from about 0.1% to about 1% by weight of Fructo-oligosaccharides (FOS), on a dry matter basis.

11. The wet food composition of claim 3, wherein the source of soluble fiber is selected from beet pulp, guar gum, chicory pulp, chicory root, psyllium, pectin, blueberry, cranberry, squash, apples, oats, beans, citrus, barley, peas, inulin, corn, or a combination thereof.

12. The wet food composition of claim 1, wherein the wet food composition is a loaf or a chunk in sauce.

13. The use of a nutritionally complete wet food composition of claim 1, for managing an intestinal disorder in a companion animal.

14. The use of a nutritionally complete wet food composition of claim 13, wherein the intestinal disorder comprises constipation, colitis, anal incontinence, intestinal dysmotility, megacolon, acute colitis, chronic colitis, chronic enteropathy, chronic idiopathic large bowel disease, dysautonomia, obstipation and/or inflammatory bowel disease, preferably the intestinal disorder consists of constipation.

15. A method for managing an intestinal disorder in a companion animal comprising a step of administering a nutritionally complete wet food composition of claim 1 to the companion animal.

16. The wet food composition of claim 4, wherein the source of insoluble fiber is selected from cellulose, whole wheat products, wheat oat, corn bran, flax seed, grapes, celery, psyllium, green beans, cauliflower, potato skins, fruit skins, vegetable skins, peanut hulls, soy fiber, beet pulp, or a combination thereof.
